(19) United States
(12) Patent Application Publication
(10) Pub. No.: US 2019/0184803 A1
(43) Pub. Date: Jun. 20, 2019

(54) COMPONENT MOUNT AND CHASSIS INCORPORATING SAME

(71) Applicants: David Martin Strange, Potterville, MI (US); Johann Pieter Eloff, Fort Wayne, IN (US); Michael David Hundt, Lansing, MI (US)

(72) Inventors: David Martin Strange, Potterville, MI (US); Johann Pieter Eloff, Fort Wayne, IN (US); Michael David Hundt, Lansing, MI (US)

(73) Assignee: Spartan Motors, Inc., Charlotte, MI (US)

(21) Appl. No.: 15/847,560

(22) Filed: Dec. 19, 2017

(51) Int. Cl. B60K 5/12; B62D 21/02; B62D 65/10

(52) U.S. Cl. CPC B60K 5/1216; B62D 65/10; B62D 21/02

(57) ABSTRACT

A component mount and chassis incorporating same are provided. The component mount includes a frame rail side portion having a first surface and a component side portion having a second surface facing the first surface. The first and second surfaces bound an interior space of the component mount. One or more damping elements are situated within the interior space. A chassis incorporating the aforementioned mount includes a frame rail which includes a cut out that has been formed prior to bending the frame rail into its final shape. The component mount is mounted to the frame rail and accessible through the cut out.

### FIELD OF THE INVENTION

This invention generally relates to motor vehicles, and more particular to chassis and motor mount design.

### BACKGROUND OF THE INVENTION

Standard construction of a relatively larger motor vehicle such as a motor home or a passenger bus typically requires construction of a chassis that may typically provide the mechanical workings of such vehicles. The chassis will typically carry the suspension, the engine, transmission, etc. To achieve this, additional mounting structures or “mounts” are utilized to mount many of such componentry.

For example, motor mounts may be used for mounting the motor to the chassis, and more particularly the frame rails of the chassis, to support the motor. The same holds true for the transmission. In either case, the mounts themselves must be of a robust construction to support the weight and loading characteristics of such large and heavy mechanical devices and must also provide a vibration dampening function such that undamped vibrations are not transferred from the chassis to these devices and vice versa.

As a result, such mounts are relatively complex in nature. They typically involve a frame rail side portion and a component (e.g. an engine or a transmission) side portion. Damping elements are used to connect the frame rail side portion to the component side portion in an effort to reduce or eliminate mechanical vibrations between these components.

One example of such a complex configuration includes a chassis having a pair of frame rails. A pair of component mounts are used to connect an engine or other component to the frame rails. These mounts are relatively large. As introduced above, they include a frame rail side portion and a component side portion. A pair of damping element assemblies is positioned between the aforementioned portions. The upper portions of these damping element assemblies is exposed above an upper surface of the component side portion of each mount. These damping element assemblies are secured to the component side and frame rail side portions via bolt respectively, which extends through the damping element assemblies. The ends of these bolts face upwardly given that the bolts extend generally perpendicular to the length of the frame rails.

As such, in order to decouple the frame rail side portion from the component side portion, these bolts must be removed. Such decoupling is necessary when it is desirable to remove the engine or other component, and is also a prerequisite to installing the engine or other component. As such, such bolts must be readily accessible in the direction which is perpendicular to the length of the frame rail.

The frame rails themselves have a U-shaped cross section such that upper and lower flanges extend laterally into the space between the rails. The component mounts are situated between the flanges and mount to an interior surface of the frame rails. To facilitate access to the aforementioned bolts, the upper flange must include a cut out to unmask the otherwise hidden bolts of the component mounts. The upper flange would otherwise cover (and thus prevent access to) the mounts if the cut outs were not present.

Unfortunately, due to the larger size of the component mounts, the cut outs themselves must be relatively large and thus must be formed after the U-shaped cross section of the frame rails is implemented. In other words, the frame rails are first bent into shape, and then the cut outs are formed.

This forming is typically done via torch cutting, and is done in close proximity to a stress concentration region in the frame rails, i.e. the bend near the upper flange. Given that torch cutting is itself a stress inducing process, the region of the cut outs has a tendency to be a high residual stress region after being bent and then subjected to torch cutting. This can lead to stress fractures in the frame rails in the region of the cut outs in the field.

On approach to avoiding the above residual stresses has been to omit the cut out entirely. This, however, means that the component mounts must first be disconnected from the component entirely prior to removing the component mounted by the mounts. In the example of an engine, the component mounts must first be disconnected from the component in order to remove the engine. Given that the bolts which mount the component mount to the component are in a very difficult space to reach by hand (and even more difficult with a tool), this approach is undesirable.

Accordingly, there is a need in the art for a component mount and a chassis incorporating the same which does not require such large cut outs to provide access to the component mount. The invention provides such a component mount and chassis incorporating same. These and other advantages of the invention, as well as additional inventive features, will be apparent from the description of the invention provided herein.

### BRIEF SUMMARY OF THE INVENTION

In one aspect, the invention provides a component mount for use with a chassis assembly. An embodiment of such a component mount includes a frame rail side configured for mounting to a frame rail of a chassis. The frame rail side portion includes a partition plate. This embodiment also includes a component side portion configured for connection to a component. At least one upper damping element extends above the partition plate. At least one lower damping element is axially aligned with the at least one upper damping element about a common longitudinal axis. The at least one lower damping element extends below the partition plate such that the partition plate is interposed between the at least one upper damping element and the at least one lower damping element.

In certain embodiments, the at least one upper damping element includes a first bore and the at least one lower damping element includes a second bore. The first and second bores are axially aligned with one another to receive a fastener. A sleeve surrounds the fastener within the first and second bores.

In certain embodiments, the at least one upper damping element and the at least one lower damping element each have a first portion having a first outer diameter and a second portion having a second outer diameter less than the first outer diameter. The component mount may also include a spacer plate in contact with the partition plate. The second portion of the at least one upper damping element extends into a bore of one of the spacer plate or the partition plate. The second portion of the at least one lower damping element extends into a bore of the other one of the spacer plate and or partition plate. The bore of the spacer plate and the bore of the partition plate are aligned with one another.

In certain embodiments, a gap is formed between an axial face of the second portion of the at least one upper damping element and an axial face of the second portion of the at least one lower damping element.

In certain embodiments, the component mount also includes a pair of washer plates, wherein the at least one upper damping element and the at least one lower damping element are interposed between the pair of washer plates.

In certain embodiments, the at least one upper damping element includes a plurality of upper damping elements, and the at least one lower damping element includes a plurality of lower damping elements. The plurality of upper damping elements are arranged in a row. The plurality of lower damping elements are arranged in a row. Each one of the plurality of upper damping elements is aligned with each one of the lower damping elements, respectively.

In another aspect, the invention provides a chassis assembly for a motor vehicle. An embodiment of such a chassis assembly includes a pair of opposed frame rails each having a U-shaped cross section with a base section and upper and lower flanges extending from the base section in an opposed spaced relationship. This embodiment also includes at least one pair of opposed component mounts. Each component mount includes a frame rail side portion configured for mounting to an interior surface of the base section.

This embodiment also includes a component side portion configured for connection to a component. The component side portion includes a mounting wall for mounting to the base section of the frame rail and a support wall extending transverse to the mounting wall. This embodiment also includes at least one upper damping element interposed between the frame rail side portion and the component side portion as well as at least one lower damping element interposed between the frame rail side portion and the component side portion.

The at least one lower damping element is axially aligned with the at least one upper damping element about a common longitudinal axis defined by the aligned at least one upper damping element and the at least one lower damping element. The at least one upper damping element is situated axially above the at least one lower damping element relative to the common longitudinal axis. The at least one upper damping element and the at least one lower damping element are entirely below the support wall relative to the common longitudinal axis.

In certain embodiments, the at least one upper damping element includes a first bore and the at least one lower damping element includes a second bore. The first and second bores are axially aligned with one another to receive a fastener. A sleeve surrounds the fastener within the first and second bores.

In certain embodiments, the at least one upper damping element and the at least one lower damping element each have a first portion having a first outer diameter and a second portion having a second outer diameter less than the first outer diameter. The component mount may also include a spacer plate in contact with the partition plate. The second portion of the at least one upper damping element extends into a bore of one of the spacer plate or the partition plate. The second portion of the at least one lower damping element extends into a bore of the other one of the spacer plate and or partition plate. The bore of the spacer plate and the bore of the partition plate are aligned with one another.

In certain embodiments, a gap is formed between an axial face of the second portion of the at least one upper damping element and an axial face of the second portion of the at least one lower damping element.

In certain embodiments, the component mount also includes a pair of washer plates, wherein the at least one upper damping element and the at least one lower damping element are interposed between the pair of washer plates.

In certain embodiments, the at least one upper damping element includes a plurality of upper damping elements, and the at least one lower damping element includes a plurality of lower damping elements. The plurality of upper damping elements are arranged in a row. The plurality of lower damping elements are arranged in a row. Each one of the plurality of upper damping elements is aligned with each one of the lower damping elements, respectively.

In yet another aspect, a method for forming a chassis assembly of a motor vehicle is provided. An embodiment of this method includes of a motor vehicle providing a pair of frame rails, which includes first forming a cut out in a flat sheet and subsequently bending the flat sheet after forming the cut out into the frame rail. The resultant bent frame rail has a U-shaped cross section after bending with a base section and opposed upper and lower flanges, with the cut out being situated in the upper flange. This embodiment also includes mounting a pair of component mounts to the pair of frame rails, respectively, such that each component mount is accessible through each cut out of each frame rail.

In certain embodiments, the step of providing the pair of frame rails includes forming the cut out such that the upper flange has a reduced width in the region of the cut out.

In certain embodiments, the step of mounting the pair of component mounts to the pair of frame rails, respectively, includes, for each one of the pair of component mounts, mounting a frame rail side portion to the base section of the component mount and mounting a component to a component side portion of the component mount. The component mount includes at least one upper damping element and at least one lower damping element. The frame rail side portion includes a partition plate is interposed between the at least one upper damping element and the at least one lower damping element.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a chassis assembly which incorporates an embodiment of a component mount according to the teachings herein;

FIG. 2 is a perspective view of the component mount of FIG. 1;

FIG. 3 is an exploded view of the component mount of FIG. 2;

FIG. 4 is a cross section of the component mount of FIG. 2;

FIG. 5 is a perspective view of another embodiment of a chassis assembly which incorporates another embodiment of a component mount according to the teachings herein;

FIG. 6 is a perspective view of the component mount of FIG. 5;

FIG. 7 is an exploded view of the component mount of FIG. 6;

FIG. 8 is a cross section of the component mount of FIG. 6; and

FIG. 9 is a perspective view of the chassis assembly of FIG. 1, illustrating a cut out formed in the frame rails of the chassis assembly; and

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, the same illustrate embodiments of a chassis assembly and a component mount associated with the chassis assembly. The component mount has compact design compared to prior designs. This in turn allows a frame rail of chassis assembly attached to utilize a much smaller cut out for accessing the component mount in comparison to those prior designs discussed above that incorporate a larger cut out. Because this cut out is much smaller, it may be implemented prior to bending the frame rail into its U-shaped cross sectional shape, instead of after bending the frame rail into its U-shaped cross sectional shape as is done in prior designs. This significantly reduces the residual stresses in that region.

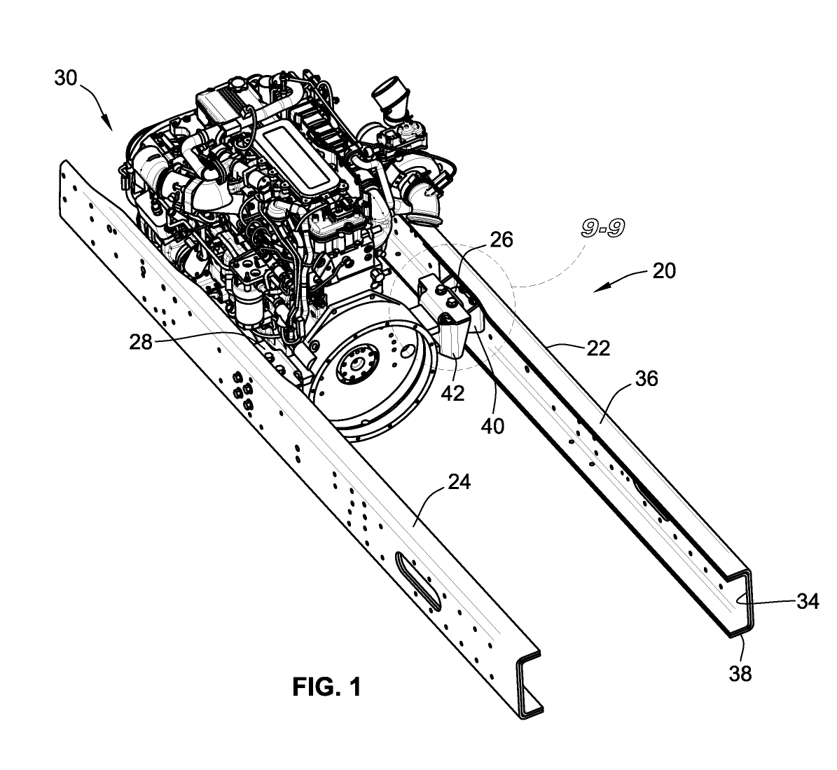

Turning now to FIG. 1, a chassis assembly 20 (hereinafter referred to as assembly 20) according to the teachings herein is illustrated. Assembly 20 includes a pair of opposed frame rails 22, 24 each having a U-shaped cross-section as illustrated. Although not shown, it will be readily recognized that assembly 20 also includes lateral support members extending between frame rails 22, 24 and other componentry typical of chassis designs. For purposes of describing the invention, however, these additional components are not shown as they are not necessary for the description herein.

A pair of component mounts 26, 28 are mounted to each frame rail 22, 24, respectively. More specifically, each frame rail includes a base section 34 and upper and lower flanges 36, 38. The term “lower” in the context of lower flange 38 is used to denote the flange which is closest to a road surface during operation of a vehicle incorporating assembly 20. The term “upper” in the context of upper flange 36 is used to denote the flange which is vertically above lower flange 38. With particular reference to component mount 26, the same mounts directly to base section 34 as shown. An identical configuration is also present for frame rail 24 and component mount 28. As such, any description of one component mount applies equally well to the other, and any description of one frame rail applies equally well to the other.

Component mount 26 includes a frame rail side portion 40 and a component side portion 42 as shown. As may be surmised from FIG. 1, frame rail side portion 40 is configured to mount to frame rail 22, and more particularly, base section 34 as mentioned above. To configure frame rail side portion 40 to achieve such mounting, the same may include a hole pattern or the like for receiving bolts which pass through frame rail 22 to join frame rail side portion 40 to frame rail 22, as one non-limiting example. Further, frame rail side portion 40 may incorporate a generally flat surface to allow for flush mounting frame rail side portion 40 against frame rail 22.

Similarly, component side portion 42 is configured to mount with or receive a component 30. This configuration may be achieved by providing component side portion 42 with a hole pattern or the like for receiving bolts which are used to join component 30 to component side portion 42. Further, component side portion 42 may incorporate a generally flat surface to allow for flush mounting component 30 against component side portion 42. Of course, it is entirely possible to use other means of mechanical joining to join frame rail side portion 40 to frame rail 22 as well as component side portion 42 to component 30.

Component 30 is illustrated in the form of an engine block. However, mounts 26, 28 may be utilized to mount any component typically mounted to a frame rail of a chassis. As will be discussed below, and as one non-limiting example, the teachings herein may be readily applied to a mount for mounting a transmission to a frame rail as well.

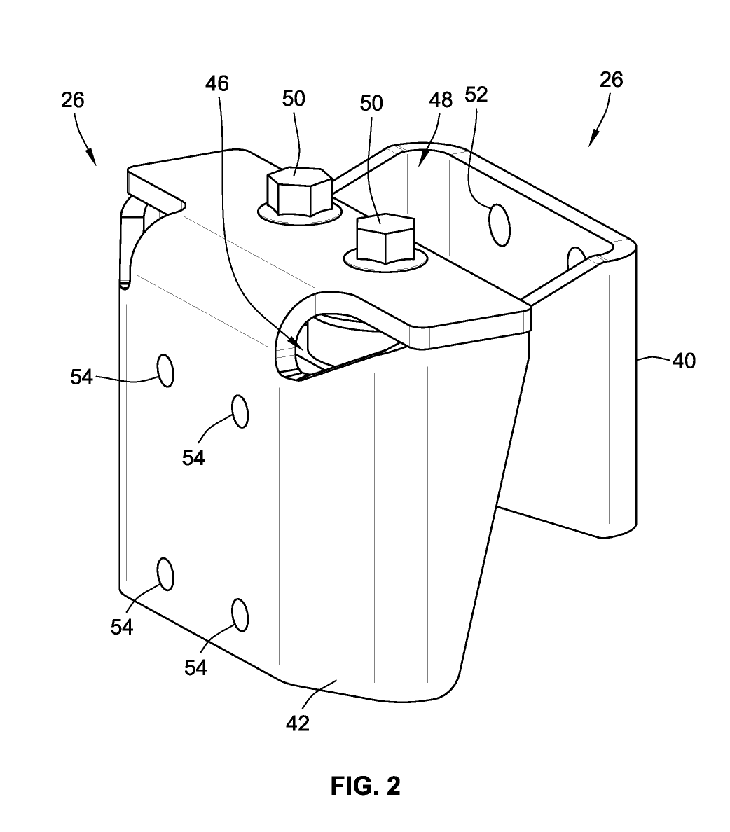

Turning now to FIG. 2, the same illustrates component mount 26 disconnected from frame rail 22. As already mentioned above, component mount 26 is identical to component mount 28. For purposes of brevity, only component mount 26 is described herein. However, this description applies equally well to component mount 28. As mentioned above, component mount 26 includes a frame rail side portion 40 and a component side portion 42.

An interior space 46 is formed between these portions 40, 42. A damping arrangement 48 is contained within interior space 46. As will be described in greater detail below, this damping arrangement 48 includes at least one upper damping element and at least one lower damping element which is axially aligned with the upper damping element. Bolts 50 are utilized to fasten frame rail side portion 40 to component side portion 42. Frame rail side portion 40 employs one or more bolt holes 52 for connecting to frame rail 22 as discussed above. Similarly, component side portion 42 includes one or more bolt holes 54 for connecting frame rail side portion to component 30 (see FIG. 1).

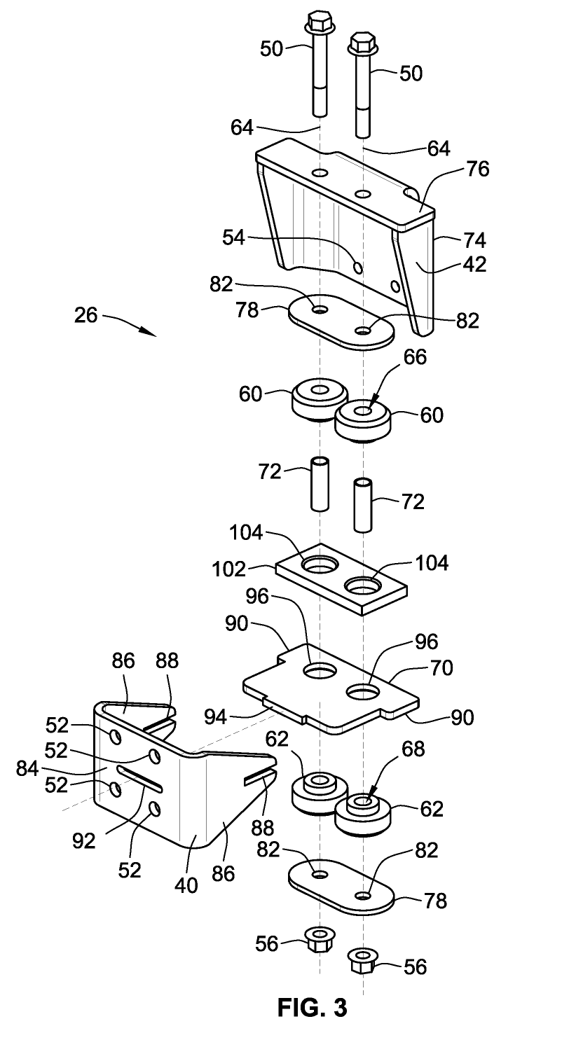

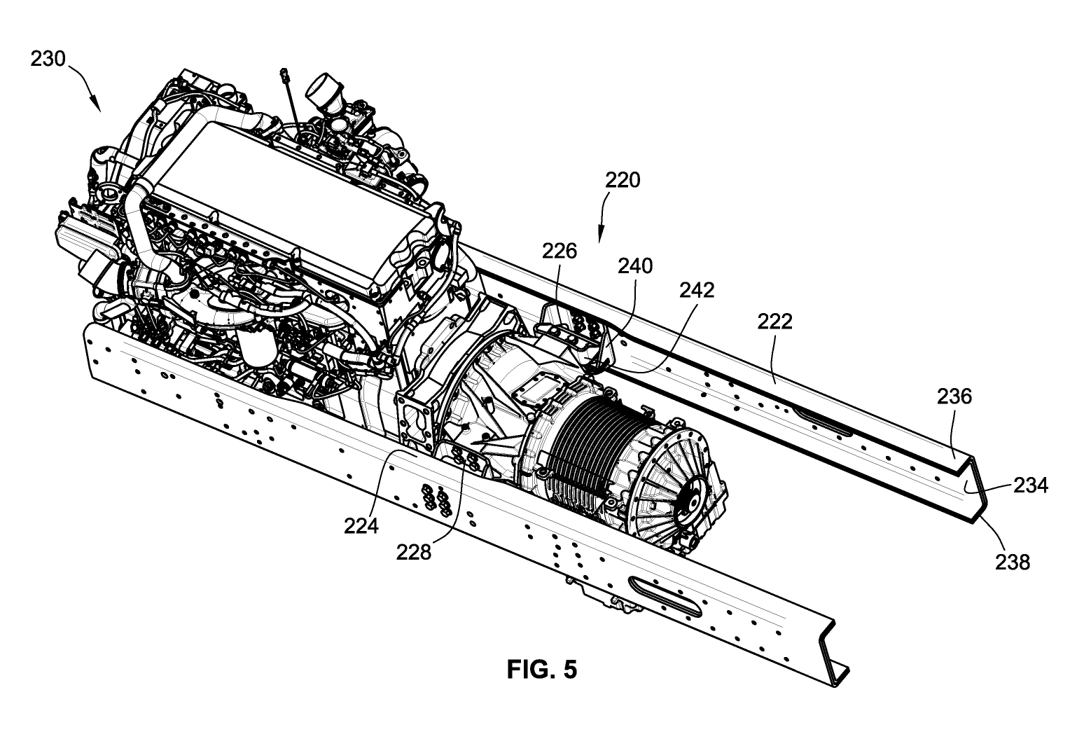

Turning now to FIG. 3, component mount 26 is illustrated in an exploded view. As mentioned above, damping arrangement 48 (see FIG. 2) includes at least one upper damping element 60 and at least one lower damping element 62. In the illustrated embodiment, there are two identical upper damping elements 60 and two identical lower damping elements 62. In other embodiments, there may only be a single upper damping element and a single lower damping element, or alternatively as shown in FIGS. 5-8, more than two upper damping elements and more than two lower damping elements. The number of upper and lower damping elements is entirely dependent upon the expected loading of component mount 26, as well as the desired damping characteristics.

As may be seen from FIG. 3, upper damping element 60 is aligned with lower damping element 62 to define a common longitudinal axis 64. As its name implies, upper damping element 60 is axially above lower damping element 62 relative to longitudinal axis 64. Each pair of upper and lower damping elements employs the same aligned arrangement described above.

Upper damping element 66 includes a bore extending therethrough. Similarly, lower damping element 62 includes a bore 68 extending therethrough. These bores 66, 68 are aligned along longitudinal axis 64 to receive bolts 50 as illustrated. Bolts 50 extend through upper and lower damping element 60, 62 and are tightened via nuts 56 as shown. Additionally, a sleeve 72 may extend through bores 66, 68 to receive bolts 50 as illustrated.

Component side portion 42 includes a mounting portion 74 and a support portion 76 which extends generally transverse to mounting portion 74. Support portion 76 exerts a downward force against upper and lower damping elements 60, 62 as bolts 50 are tightened. Although not a requirement, washer plates 78 may also be employed to uniformly distribute the force exerted against upper and lower damping elements 60, 62. To this end, each washer plate 78 include bores 82 therethrough for the passage of fasteners 50.

A partition plate 70 of frame rail side portion 40 is interposed between upper and lower damping element 60, 62 as shown. In this way, frame rail side portion 40 is linked or connected to component side portion 42. Partition plate 70 includes bores 96 which are aligned with longitudinal axes 64. These bores 96 receive a portion of lower damping elements 62 as described below, and also allow for passage of bolts 50 through partition plate 70.

Frame rail side portion 40 includes a mounting portion 84 through which the above-introduced bolt holes 52 are formed. A pair of side portions 86 depend outwardly from mounting portion 84 as shown. Each side portion 86 includes a slot 88 for receipt of corresponding tabs 90 formed in partition plate 70. Additionally, mounting portion 84 includes a slot 92 for receipt of a corresponding tab 94 of partition plate 70. Tabs 90, 94 may be press fit, welded, braised or fixed in place in their corresponding slots 88, 92 using any other known mechanical connection.

Additionally, a spacer plate 102 may be positioned on top of partition plate 70 as shown. Spacer plate 102 includes bores 104 therethrough aligned along longitudinal axes 64. These bores 104 receive a portion of upper damping elements 60 as described below, as well as permit passage of bolts 50 therethrough. It should be noted that while spacer plate 102 is illustrated as a separate component from partition plate 70, partition plate 70 and spacer plate 102 may be formed as a single unitary component in other embodiments. Further, spacer plate 102 may simply rest upon a top surface of partition plate 70, or it may be fixed to partition plate 70 using any known mechanical joining means.

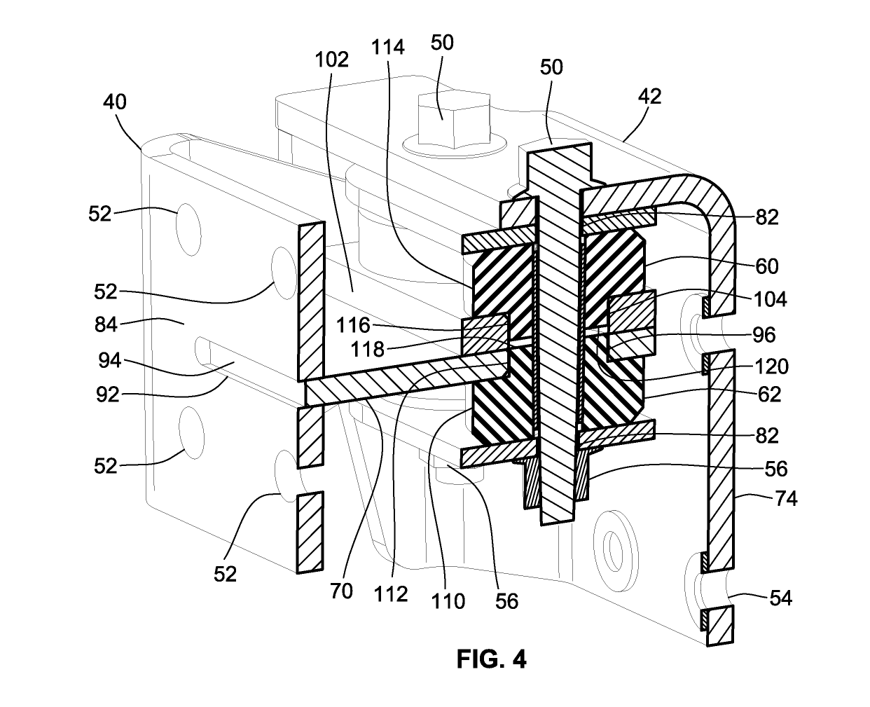

Turning now to FIG. 4, the same illustrates a cross-section taken through upper and lower damping element 60, 62. Lower damping element 62 includes a first portion 110 and a second portion 112 extending axially from first portion 110. Second portion 112 has a smaller outer diameter than first portion 110. Second portion 112 is received within bores 96 of partition plate 70.

Similarly, upper damping element 60 includes a first portion 114 and a second portion 116 depending axially from first portion 114. Second portion 116 has an outer diameter which is smaller than an outer diameter of first portion 114. Second portion 116 is received within bores 104 of spacer 102 as may be seen in FIG. 4, second portion 112 of lower damping element 62 includes an axial face 118 which faces an axial face 120 of second portion 116 of upper damping elements 60. A gap is formed between these axial faces 118, 120 to allow for expansion of upper and lower damping elements 60, 62 during loading.

The overall construction of component mounts 26, 28 as well as the arrangement of upper and lower damping elements 60, 62 allows for utilizing a smaller outer diameter for first portions 110, 114 compared to prior designs. Indeed, prior designs typically employ damping elements ranging in outer diameter from about 2.5 inches to about 4 inches, whereas first portions 110, 114 may employ an outer diameter of about 2 inches. The term “about” is used in the context to allow for typical manufacturing tolerances in damping element design.

Turning now to FIGS. 5-8, the same illustrate an alternative embodiment of a chassis assembly 220 (hereinafter referred to as assembly 220). With particular reference to FIG. 5, assembly 220 includes a pair of identical frame rails 222, 224. As such, a description of one frame rail 222, 224 applies equally well to the other. A pair of identical component mounts 226, 228 are mounted to frame rails 222, 224, respectively. Component mounts 226, 228 are identical to one another. As such, a description of one applies equally well to the other. These component mounts 226, 228 are similar in construction to component mounts 26, 28 described above with notable differences discussed below. Component mounts 226, 228 are used to mount a component 230 to assembly 220. In this particular embodiment, the component in this instance is a transmission.

Each frame rail has a U-shaped cross-section and includes a base section 234, with upper and lower flanges 236, 238 depending inwardly from base section 234 as shown. With exemplary reference to component mount 226, the same includes a frame rail side portion 240 which is configured to mount to base section 234 of frame rail 222, as well as a component side portion 242 which is configured to mount to component 230. Frame rail side portion 240 and component side portion 242 are configured to mount to frame rail 222 and component 230, respectively, in the same manner as described above relative to frame rail side portion 40 and component side portion 42.

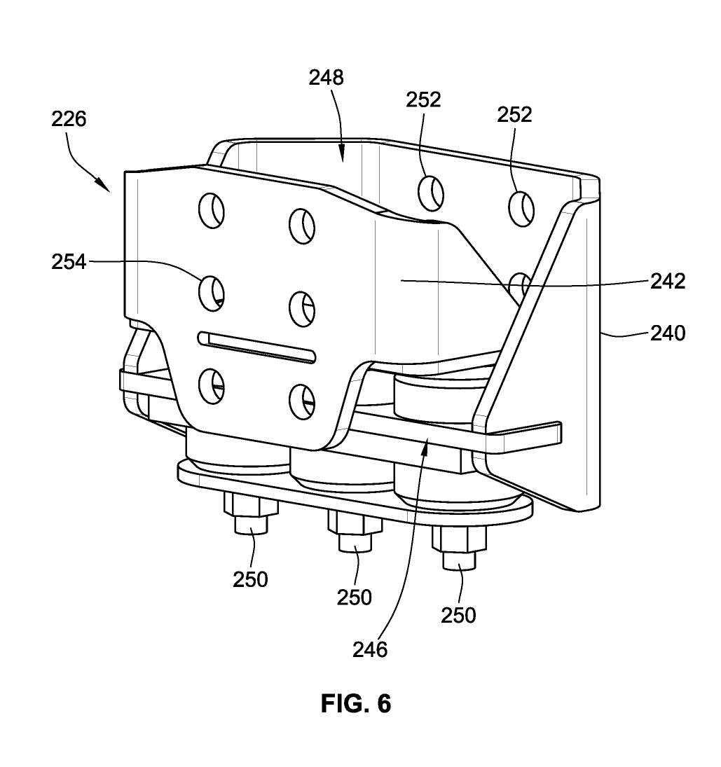

Turning now to FIG. 6, component mount 226 is shown in a perspective view. An interior space 246 is formed between frame rail side portion 240 and component side portion 242. A damping arrangement 248 is positioned within interior space 246. This damping arrangement 248 is identical to damping arrangement 48 described above, except for the differences discussed below.

Frame rail side portion 240 includes a plurality of bores 252 for receiving bolts used to mount frame rail side portion 242 frame rail 222 (see FIG. 5). Similarly, component side portion 242 includes a plurality of bores 254 for receiving bolts for mounting component 230 (see FIG. 5) to component side portion 242.

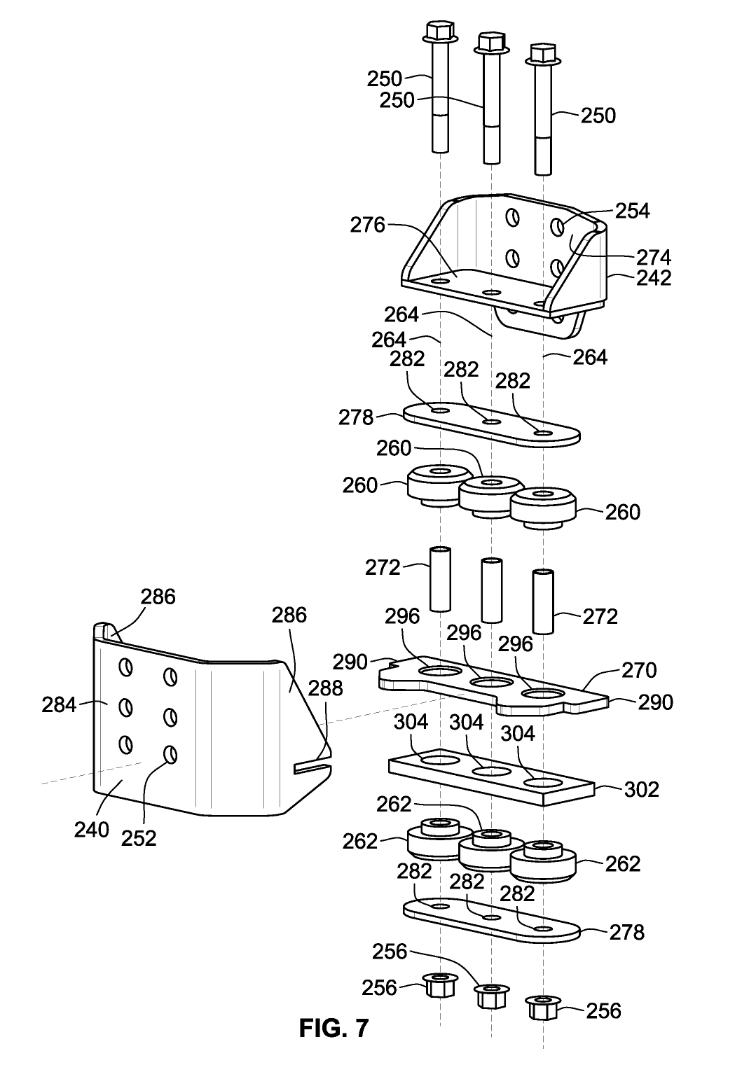

FIG. 7 illustrates component mount 226 in an exploded view. As will be immediately apparent from inspection of FIG. 7, the same incorporates three upper damping elements 260 and three lower damping elements 262. Each upper damping element 260 is aligned with a corresponding lower damping element 262 in the same manner as described above relative to FIG. 3. As such, each aligned pair of upper damping element 260 and lower damping element 262 defines a common longitudinal axis 264 as shown. Upper and lower damping element 260, 262 each include a bore 266, 268, respectively, therethrough for receipt of bolts 250. A sleeve 272 may also be positioned within these aligned bores 266, 268 for receiving the corresponding bolt 250.

Component side portion 242 includes a mounting portion 274 and a support portion 276 extending transverse to mounting portion 274. Support portion 276 exerts a downward force against upper and lower damping elements 260, 262 as bolts 250 are tightened via tightening of nuts 256. Although not a requirement, washer plates 278 may also be utilized to distribute the loading evenly across upper and lower damping element 260, 262. To this end, each washer plate 278 includes corresponding bores 282 which are aligned along longitudinal axes 264 to allow for passage of bolts 250 therethrough.

A partition plate 270 of frame rail side portion 240 is interposed between upper and lower damping elements 260, 262 as shown. In this way, frame rail side portion 240 is linked or otherwise connected to the mounting portion 242.

Frame rail side portion 240 includes a mounting portion 284 and a pair of side portions 286 depending outwardly from mounting portion 284. Each side portion 286 includes a slot 288 which receives a corresponding tab 290 of partition plate 270. Tabs 290 may be attached to slots 288 via any mechanical connection means.

Partition plate 270 includes a plurality of bores 296 each of which is aligned along a corresponding longitudinal axis 264. As described below, a portion of upper damping elements 260 are respectively received within bores 296 of partition plate 270. Bores 296 also permit passage of bolts 250 through partition plate 270.

A spacer plate 302 may also be provided and is in contact with partition plate 270. Spacer plate 302 includes a plurality of bores 304 each of which is respectively aligned along a corresponding longitudinal axis 264. A portion of lower damping elements 262 extends into bores 304. Bores 304 also permit passage of bolts 250 through spacer plate 302. Although illustrated as a separate component, spacer plate 302 may be formed as a single unitary component with partition plate 270. Further, spacer 304 may rest against partition plate 270 or may be fixed to partition plate 270 via any mechanical connection means.

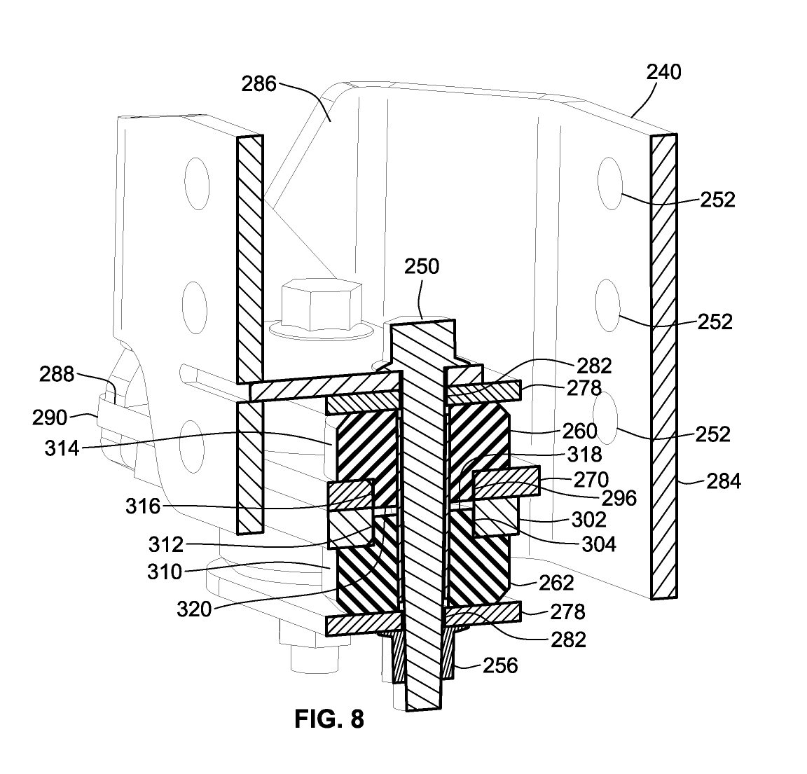

Turning now to FIG. 8, the same illustrates a cross-section taken through upper and lower damping elements 260, 262. Lower damping element 262 includes a first portion 310 and a second portion 312. Second portion 312 has an outer diameter which is less than an outer diameter of 310. Second portion 312 is received within bore 304 of spacer 302.

Upper damping element 260 includes a first portion 314 and a second portion 316. Second portion 316 has an outer diameter which is less than an outer diameter of first portion 314. Second portion 316 is received within apertures 296 of spacer plate 270. Second portion 312 of lower damping element 262 includes an axial face 318. Second portion 316 of upper damping element 260 also includes an axial face 320 which faces axial face 318. A gap is formed between these axial faces 318, 322 permit expansion of upper and lower damping elements 260, 262 during loading.

The overall construction of component mounts 226, 228 as well as the arrangement of upper and lower damping elements 260, 262 allows for utilizing a smaller outer diameter for first portions 210, 214 compared to prior designs. Indeed, prior designs typically employ damping elements ranging in outer diameter from about 2.5 inches to about 4 inches, whereas first portions 210, 214 may employ an outer diameter of about 2 inches. The term “about” is used in the context to allow for typical manufacturing tolerances in damping element design.

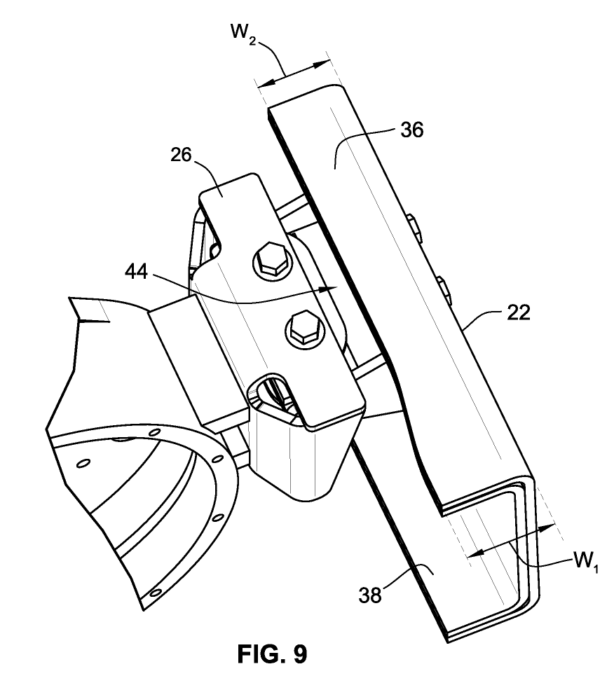

Turning now to FIG. 9, the same illustrates a partial view of assembly 20 illustrated in FIG. 1. A section of frame rail 22 is illustrated. As mentioned above, frame rail 22 is identical to frame rail 222 for purposes of this disclosure. As such, the following description applies equally well to frame rail 222 in the context of assembly 220. A cutout 44 is implemented in top flange 36 as shown. Because of the compact design of component mount 26, the depth of this cutout 44 is considerably less than prior designs. Indeed, flange 36 typically has a width W₁ outside of the region of cutout 44. In the region of cutout 44, however, flange 36 has a width W₂.

The difference between widths W₁ and W₂ is about one half of an inch to about one inch. The term “about” in this instance is used to provide for typical manufacturing tolerances in chassis fabrication. Because of the relatively minimal nature of this cutout depth, it is now possible to bend frame rail 22 into its U-shaped cross-section after forming the cutout 44. In other words, cutout 44 is implemented in a flat sheet. This flat sheet is then formed into the U-shaped cross-section to make frame rail 22.

The foregoing order of operations of cutting and then bending has a significant advantage over prior designs. Indeed, as discussed above, with prior designs typically the cutout is implemented after the frame rail is formed into its U-shaped cross-section. In this method, a significant residual stress remains given the high stress nature of the cutting operation and given that there are already stress concentrations as a result of bending in the region of the bend.

As such, one exemplary method of forming a chassis assembly according to the teachings herein includes providing a pair of frame rails by first forming a cutout in a flat sheet and then subsequently bending the flat sheet after performing the cutout into the frame rail. Thereafter, the above discussed component mounts can be readily mounted to their associated frame rail. Such a configuration also allows for ready access to the component mounts from the top, i.e., the direction which is perpendicular to the length of the frame rails to readily disconnect component mounts from the remainder of the assembly.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A component mount for use with a chassis assembly, the component mount comprising:
a frame rail side portion, the frame rail side portion configured for mounting to a frame rail of a chassis, wherein the frame rail side portion includes a partition plate;
a component side portion, the component side portion configured for connection to a component;
at least one upper damping element extending above the partition plate;
at least one lower damping element axially aligned with the at least one upper damping element about a common longitudinal axis, the at least one lower damping element extending below the partition plate such that the partition plate is interposed between the at least one upper damping element and the at least one lower damping element.

2. The component mount of claim 1, wherein the at least one upper damping element includes a first bore, and wherein the at least one lower damping element includes a second bore, wherein the first and second bores are axially aligned with one another to receive a fastener.

3. The component mount of claim 2, further comprising a sleeve surrounding the fastener within the first and second bores.

4. The component mount of claim 1, wherein the at least one upper damping element and the at least one lower damping element each have a first portion having a first outer diameter and a second portion having a second outer diameter less than the first outer diameter.

5. The component mount of claim 4, further comprising a spacer plate, the spacer plate in contact with the partition plate, wherein the second portion of the at least one upper damping element extends into a bore of one of the spacer plate or the partition plate, and wherein the second portion of the at least one lower damping element extends into a bore of the other one of the spacer plate and or partition plate, the bore of the spacer plate and the bore of the partition plate aligned with one another.

6. The component mount of claim 4, wherein a gap is formed between an axial face of the second portion of the at least one upper damping element and an axial face of the second portion of the at least one lower damping element.

7. The component mount of claim 1, further comprising a pair of washer plates, wherein the at least one upper damping element and the at least one lower damping element are interposed between the pair of washer plates.

8. The component mount of claim 1, wherein the at least one upper damping element includes a plurality of upper damping elements, and wherein the at least one lower damping element includes a plurality of lower damping elements.

9. The component mount of claim 1, wherein the plurality of upper damping elements are arranged in a row and wherein the plurality of lower damping elements are arranged in a row, and wherein each one of the plurality of upper damping elements is aligned with each one of the lower damping elements, respectively.

10. A chassis assembly for a motor vehicle, the chassis comprising:
a pair of opposed frame rails, wherein each frame rail has a U-shaped cross section with a base section and upper and lower flanges extending from the base section in an opposed spaced relationship;
at least one pair of opposed component mounts, wherein each component mount comprises:
a frame rail side portion, the frame rail side portion configured for mounting to an interior surface of the base section;
a component side portion, the component side portion configured for connection to a component, the component side portion including a mounting wall for mounting to the base section of the frame rail, and a support wall extending transverse to the mounting wall; and
at least one upper damping element interposed between the frame rail side portion and the component side portion;
at least one lower damping element interposed between the frame rail side portion and the component side portion and axially aligned with the at least one upper damping element about a common longitudinal axis defined by the aligned at least one upper damping element and the at least one lower damping element;
wherein the at least one upper damping element is situated axially above the at least one lower damping element relative to the common longitudinal axis; and
wherein the at least one upper damping element and the at least one lower damping element are entirely below the support wall relative to the common longitudinal axis.

11. The chassis assembly of claim 10, wherein the at least one upper damping element includes a first bore, and wherein the at least one lower damping element has a second bore, wherein the first and second bores are axially aligned with one another to receive a fastener.

12. The chassis assembly of claim 10, wherein the at least one upper damping element and the at least one lower damping element each have a first portion having a first outer diameter and a second portion having a second outer diameter less than the first outer diameter.

13. The chassis assembly of claim 12, further comprising a spacer plate, the spacer plate in contact with the partition plate, wherein the second portion of the at least one upper damping element extends into a bore of one of the spacer plate or the partition plate, and wherein the second portion of the at least one lower damping element extends into a bore of the other one of the spacer plate and or partition plate, the bore of the spacer plate and the bore of the partition plate aligned with one another.

14. The chassis assembly of claim 13, wherein a gap is formed between an axial face of the second portion of the at least one upper damping element and an axial face of the second portion of the at least one lower damping element.

15. The chassis assembly of claim 10, further comprising a pair of washer plates, wherein the at least one upper damping element and the at least one lower damping element are interposed between the pair of washer plates.

16. The chassis assembly of claim 10, wherein the at least one upper damping element includes a plurality of upper damping elements, and wherein the at least one lower damping element includes a plurality of lower damping elements.

17. The chassis assembly of claim 10, wherein the plurality of upper damping elements are arranged in a row and wherein the plurality of lower damping elements are arranged in a row, and wherein each one of the plurality of upper damping elements is aligned with each one of the lower damping elements, respectively.

18. A method for forming a chassis assembly of a motor vehicle, the method comprising:
providing a pair of frame rails, wherein the step of providing each one of the pair of frame rails includes first forming a cut out in a flat sheet and subsequently bending the flat sheet after forming the cut out into the frame rail, the frame rail having a U-shaped cross section after bending with a base section and opposed upper and lower flanges, with the cut out being situated in the upper flange; and
mounting a pair of component mounts to the pair of frame rails, respectively, such that each component mount is accessible through each cut out of each frame rail.

19. The method of claim 18, wherein the step of providing the pair of frame rails includes forming the cut out such that the upper flange has a reduced width in the region of the cut out.

20. The method of claim 20, wherein the step of mounting the pair of component mounts to the pair of frame rails, respectively, includes, for each one of the pair of component mounts, mounting a frame rail side portion to the base section of the component mount, mounting a component to a component side portion of the component mount, wherein the component mount includes at least one upper damping element and at least one lower damping element, and wherein the frame rail side portion includes a partition plate interposed between the at least one upper damping element and the at least one lower damping element.
